(19) United States
(12) Patent Application Publication
(10) Pub. No.: US 2023/0180784 A1
(43) Pub. Date: Jun. 15, 2023

(54) METHOD TO PRODUCE FOOD PRODUCTS AND FOOD PRODUCTS THUS OBTAINED

(71) Applicant: STEAMPOWER INNOVATIVA S.R.L., Verona (IT)

(72) Inventor: Gianpaolo Facco, Camposampiero (IT)

(73) Assignee: STEAMPOWER INNOVATIVA S.R.L., Verona (IT)

(21) Appl. No.: 17/995,741

(22) PCT Filed: Apr. 7, 2021
(86) PCT No.: PCT/IT2021/050095

§ 371 Date: Oct. 7, 2022

(30) Foreign Application Priority Data
Apr. 7, 2020 (IT) 202000007408

(51) Int. Cl. A23F 5/20; A23F 5/24; A23F 5/04; A23F 5/08

(52) U.S. Cl. CPC A23F 5/208; A23F 5/243; A23F 5/04; A23F 5/08

(57) ABSTRACT

Method to produce food products that provides to subject to washing a food raw material containing caffeine and already subjected to roasting in order to obtain a food product with reduced caffeine content and a flavored beverage.

### FIELD OF THE INVENTION

Embodiments described here concern a method to produce food products and the food products thus obtained.

In particular, the embodiments described here concern a method which, starting from a given food raw material in solid form and containing caffeine, supplies, after suitable processing, both a food product, essentially in the same solid form but with different organoleptic and/or sensorial properties and in particular with a reduced caffeine content, and also a flavored drink, without producing processing waste.

In particular, the food raw materials of the embodiments described here natively contain caffeine and are for example plant substances containing caffeine, such as for example coffee, tea, cocoa, maté, guarana, cola or similar or comparable substances, or other substances or raw food materials that natively contain caffeine.

### BACKGROUND OF THE INVENTION

It is known that the production of coffee entails a processing step called roasting, in which the green beans are roasted, being subjected to a temperature of 200-220° C. and shaken. As a consequence of this processing, the coffee beans increase in volume, lose weight by losing water through evaporation and change color and density. With roasting, the coffee bean acquires its typical organoleptic and sensorial properties. During this processing, the coffee bean undergoes some important transformations such as caramelization of the sugars and carbonization of the cellulose, which give the bean its typical color, as well as the formation of the volatile compounds that give it the typical aroma of roasted coffee.

Roasted coffee basically has a bitter taste, and becomes soluble in water, being more crumbly, while the raw bean is unusable for the purposes of extraction that yields aromas. Furthermore, roasted coffee is more easily reduced to powder and therefore suitable for grinding into powders with a grain size established according to the aroma extraction process.

Generally, the different types of coffee require different combinations of the roasting process parameters, typically specific time-temperature combinations, also called “roasting curves”, as well as different final colors of the bean.

It is also known that coffee natively contains caffeine and that coffee can be decaffeinated to supply a product, known as decaffeinated coffee, which, according to Italian law (Ministerial Decree 20/6/76 and subsequent amendments) and most European countries must have a residual caffeine content of no more than 0.1% by weight.

In the state of the art, decaffeination is carried out on green coffee, that is, before roasting, and is obtained through different extraction processes, which differ from each other mainly in the extracting substance used. The processing steps are common to the different systems and comprise:
swelling: the green coffee is treated with water and water vapor in order to start the extraction and “swell” the beans which, spacing their cellular structures, allow a more efficient and homogeneous extraction of the caffeine;
extraction: the green coffee is subjected to the action of a specific solvent that “captures” the caffeine and draws it out of the bean;
solvent recovery: the solvent is removed practically completely from the coffee and recovered for subsequent reuse; this operating stage is particularly accurate both for economic reasons—all the products used are very expensive and therefore waste must be minimized—and also for legal reasons—in fact, the law imposes certain maximum limits for solvent residues and moisture;
drying: almost all the moisture present is eliminated from the coffee.

The solvents used in the extraction step are generally water, ethyl acetate, supercritical carbon dioxide, liquid carbon dioxide and dichloromethane.

Generally, decaffeination is an invasive processing of the structure and properties of the coffee bean and can have an influence on the sensorial and organoleptic qualities of the coffee bean, since it is able to almost totally impoverish its organoleptic and sensorial properties. In consideration of this, the subsequent roasting step should be carried out by adopting specific parameters, roasting curves and final colors of the bean, different from those that would be used to roast green coffee beans not subjected to decaffeination. Decaffeinated coffee, therefore, is generally not roasted with the ideal roasting parameters for the specific type of coffee used; on the contrary, it generally has to be roasted at higher temperatures and possibly for longer times, to try to compensate for the almost total lack of aromas, with the consequent risk of carbonization of the coffee bean.

The above can be applied, in general, also to other food substances that on the one hand are or could be subjected to roasting, such as tea, cocoa, maté, guarana, cola or suchlike, and on the other hand natively contain caffeine, thus implying the above considerations in the case of decaffeination.

There is therefore a need to perfect a method to produce food products containing caffeine and the food products thus obtained.

In particular, one purpose of the present invention is to perfect a method to produce food products containing caffeine which on the one hand allows to apply roasting methods and parameters that are optimized for the specific type of coffee, to impart to the food raw material the necessary and desired organoleptic and sensorial properties, and on the other hand is able to supply two different finished products from the original food raw material, that is, a food product, in the form of grains or beans, leaves, even chopped, or powder, with a reduced caffeine content and, moreover, to obtain a flavored drink directly, without processing waste.

The Applicant has devised, tested and embodied the present invention to overcome the shortcomings of the state of the art and to obtain these and other purposes and advantages.

### SUMMARY OF THE INVENTION

The present invention is set forth and characterized in the independent claims. The dependent claims describe other characteristics of the present invention or variants to the main inventive idea.

In accordance with the above purposes, embodiments concern a method to produce food products. This method comprises:
supplying a food raw material natively containing caffeine, subjected to roasting;
washing in water the food raw material subjected to roasting, in order to reduce its caffeine content and also extract a determinate quantity of aromas;
drying the food raw material, roasted and subjected to washing, in order to produce with it a food product with reduced caffeine content;
complete recovery of the washing water in order to produce a flavored beverage with it, without processing waste of the method.

Other embodiments also concern a food product with reduced caffeine content and a flavored beverage both of which can be obtained with a method in accordance with the present description.

### BRIEF DESCRIPTION OF THE DRAWINGS

These and other aspects, characteristics and advantages of the present invention will become apparent from the following description of some embodiments, given as a non-restrictive example with reference to the attached drawings wherein:

FIG. 1 is a diagram of a method according to embodiments described here;

FIG. 2 is a diagram of a method according to other embodiments described here.

To facilitate comprehension, the same reference numbers have been used, where possible, to identify identical common elements in the drawings. It is understood that elements and characteristics of one embodiment can conveniently be incorporated into other embodiments without further clarifications.

### DETAILED DESCRIPTION OF SOME EMBODIMENTS

We will now refer in detail to the possible embodiments of the invention, of which one or more examples are shown in the attached drawings. Each example is supplied by way of illustration of the invention, and by way of a non-limiting example also with regards to the embodiments, the details of the construction, the phraseology and terminology. For example, one or more characteristics shown or described insomuch as they are part of one embodiment can be varied or adopted on, or in association with, other embodiments to produce another embodiment. It is understood that the present invention shall include all such modifications and variants.

Embodiments described here concern a method to produce food products starting from food raw materials containing caffeine.

In some embodiments, the food raw materials natively containing caffeine are for example vegetable substances containing caffeine, such as for example coffee, tea, cocoa, maté, guarana, cola or similar or comparable substances, or other substances or food raw materials natively containing caffeine. These food raw materials are preferably not completely water-soluble, since they are subjected to washing in water, as described in detail below.

The method described here provides that the food raw materials in question are initially subjected to roasting and, after roasting, are subjected to washing in water in order to reduce their caffeine content and also extract from the food raw materials a determinate quantity of aromas.

The food raw material subjected to washing is then dried or desiccated, that is, almost all the moisture or water present is eliminated in order to take the moisture back to normal parameters, while the washing water, since it contains a certain quantity of caffeine and extracted aromas, is used directly to produce a water-based flavored beverage. For example, the moisture content can be no higher than 11% in the case of coffee and in accordance with the Italian legislation for the sector.

In this way, two final food products are directly obtained, namely the food product with reduced caffeine content which, when suitably dried or desiccated, in fact has the same physical form as the food raw material used, and the flavored and water-based beverage, without processing waste.

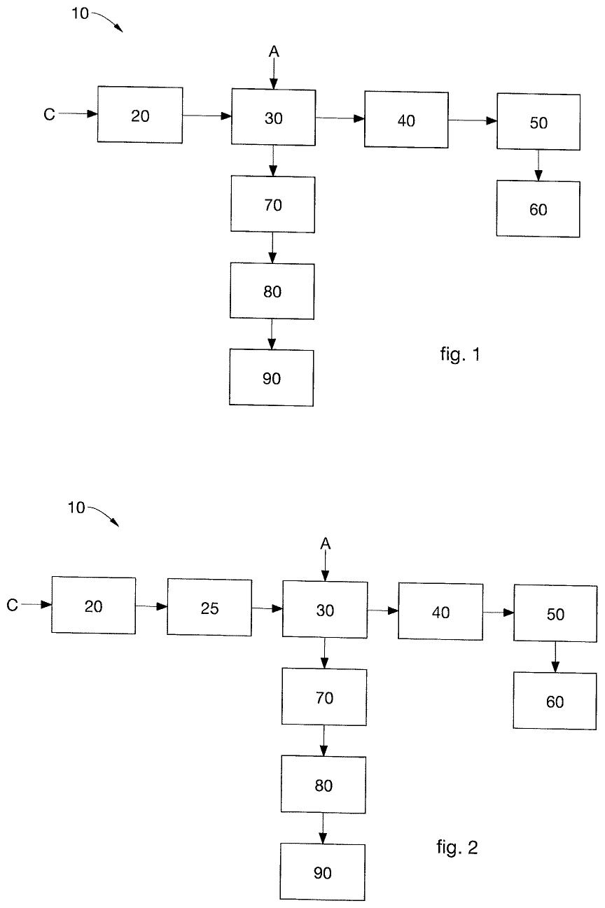

According to embodiments described here using FIGS. 1 and 2, therefore, the method according to the present invention, indicated as a whole with reference number 10, comprises:
supplying a food raw material C natively containing caffeine and subjected to roasting 20;
washing 30 in water A the food raw material C subjected to roasting 20;
drying 40 the food raw material C, roasted and subjected to washing, in order to produce with it a food product with reduced caffeine content;
complete recovery of the washing water A in order to produce a flavored beverage with it, without processing waste of the production method.

It should be noted that, in the embodiments described here, the food raw material C can be supplied already roasted or be subjected to roasting within the scope of the method described here.

In some embodiments, the method can provide, after drying 40, cooling 50 and packaging 60 the food product with reduced caffeine content.

Furthermore, in some embodiments, the method can provide that the completely recovered washing water A is subjected to pasteurization 80.

In possible implementations, the pasteurization 80 can be carried out hot, or cold, that is, at high pressure (High Pressure Processing, HPP).

In some embodiments, before the pasteurization 80, the completely recovered washing water A can be subjected to filtration 70, in order to remove any impurities resulting from the washing. Evaporation can be provided as an alternative to filtration 70, with recovery and condensation of the evaporated product on the one hand and recovery of the non-evaporated substance on the other, which can be once again added to the condensate in specific and desired doses, in order to modulate the sensory and organoleptic properties of the flavored beverage.

Downstream of pasteurization 80, the method can provide bottling 90 the flavored beverage thus obtained.

Possibly, it can be provided to add natural aromas which are also useful for the purposes of preservation, and/or specific preservative additives.

In this way, advantageously, the washing water A is completely recovered and can be marketed as a flavored beverage, reducing, if not completely eliminating, the quantity of processing waste products of the process. The beverage that is obtained has the advantage of being naturally flavored, with obvious benefits from a nutritional and health point of view, since no chemical additives or artificial aromas are used. In this way, as described above, the method of the present invention does not produce processing waste.

In possible embodiments, the food raw material C subjected to roasting 20 can be supplied in the form of granules, grains, seeds, beans, leaves. For example, in the case of coffee, it is typically supplied in granules or grains, in the case of cocoa it is supplied in beans, in the case of guarana and cola these are supplied in seeds and in the case of tea and mate these are supplied in leaves, suitably chopped. Here and hereafter in the description, the physical form of the food raw material C supplied in the form of granules, grains, seeds, beans, leaves is also defined as “incoherent” form or “incoherent material”.

In embodiments described using FIG. 1, the food raw material C does not change its physical form during the course of the method and, in fact, the food product with reduced caffeine content that is obtained has the same incoherent physical form as the start, that is, granules, grains, beans, seeds, leaves, even though it has different sensory and organoleptic properties as a consequence of the removal of part of the caffeine and the extraction of a certain quantity of aromas.

In other possible embodiments, described using FIG. 2, on the other hand the food raw material C changes its physical form during the course of the method, since it is pulverized. In fact, after being subjected to roasting 20 and before washing 30, the food raw material C in incoherent form is subjected to grinding 25. The ground powder thus obtained is then processed by washing 30 in water A and the method continues as described above.

Accordingly, according to the embodiments, the food product with reduced caffeine content can be subjected to packaging 60, obtaining for example sacks, bags, sachets, jars, cans or similar containers containing food product in an incoherent form, or in powder form.

In all the embodiments described here, the food product with reduced caffeine content that is obtained, whether it is in incoherent or powdered form, can be used to obtain a beverage typically by means of hot or cold extraction or infusion. Alternatively, the food product with reduced caffeine content can be used as an ingredient to produce other food preparations or compositions, or more complex and elaborate food products.

The food product with reduced caffeine content obtained has unique characteristics compared to traditional food products containing caffeine on the one hand and, on the other hand, food products that have been decaffeinated in a traditional manner, that is, roasted after decaffeination. The food product with reduced caffeine content is ideally positioned, in terms of caffeine content, between food products containing normal caffeine and decaffeinated ones.

Furthermore, the food product with reduced caffeine content obtained, as a consequence of the fact that roasting 20 is carried out before washing 30 with water A, that is, that washing 30 is carried out on an already roasted food raw material C, keeps the aromas, and the sensory properties of the starting food raw material C in general, almost intact, unlike the state of the art where, for the purposes of decaffeination, washing is carried out before roasting, depleting the food raw material of its organoleptic properties.

The food product with reduced caffeine content obtained has the advantage, therefore, that it can be roasted at origin with the parameters and roasting curves ideal for the given raw material, while in the state of the art the decaffeinated raw material needs to be roasted at higher temperatures in order to compensate for the lack of aromas due to the previous decaffeination.

Therefore, there is also the resulting advantage for the producer of being able to apply the same optimized roasting profile or curve qualitatively more suited to the given food raw material C, both in the case of a normal final food product and also of a food product with reduced caffeine content, preventing adopting different roasting profiles or curves that would inevitably not be specific and optimized for the raw material of origin.

The food product with reduced caffeine content can be useful for example in the case of sensitivity to caffeine or even simply to obtain a product with “reduced” or weakened organoleptic characteristics, which is more pleasant or agreeable for consumers who are looking for a more “delicate” taste.

Even the flavored beverage, by modulating the washing step, can be more or less flavored and therefore have a more marked or more delicate taste, according to the objectives of the product and flavored beverage to be achieved.

In the embodiments described here, washing 30 in water is an important step which affects the properties of the food product with reduced caffeine content obtainable, as well as of the flavored beverage. Washing 30 can be carried out by adjusting variable physical quantities characteristic of the process, in particular contact time between food raw material C and washing water A, pressure and temperature. These physical quantities can be parameterized as a function of the caffeine reduction targets in the final food product, as well as in the flavored beverage.

In particular, in some embodiments of the washing 30, the contact time can be between 1-2 seconds and 200 hours, in particular between 30 seconds and 150 hours, more particularly between 2 minutes and 72 hours, even more particularly between 3 minutes and 12 hours. A possible example is 5 minutes. Another possible example is 6 hours.

In some embodiments of the washing 30, the pressure can be between 1 bar and 20 bar, in particular between 1 bar and 10 bar, more particularly between 1 bar and 5 bar. A possible example is 1 bar. Another possible example is 3 bars.

In other embodiments of the washing 30, the temperature can be between 5° C. and 100° C., in particular between 20° C. and 90° C., more particularly between 30° C. and 80° C. A possible example is 35° C. Another possible example is 75° C.

It is clear that the example ranges or values of the varying physical quantities of the washing 30 listed above can be combined as needed, both by extrapolating or combining other ranges from the specific ranges indicated for time, temperature and pressure, and also by combining the time, pressure and temperature ranges with each other, on the basis of the caffeine reduction targets in the final food product, as well as in the flavored beverage, and also of the final taste of the product and beverage, whether more marked or more delicate.

### Example 1

A mass of 250 g of coffee granules subjected to roasting was supplied. Then the roasted coffee was washed with 5 liters of water, for a contact time of 5 minutes, a pressure of 1 bar and a temperature of 35° C.

The washing water was completely recovered, filtered and hot pasteurized in order to obtain a flavored beverage. The food product with reduced caffeine content was instead dried in hot air until a moisture content not exceeding 11% was obtained, and then cooled and packaged.

### Example 2

A mass of 250 g of coffee granules subjected to roasting was supplied. Then the roasted coffee was ground and then the roasted and ground coffee was subjected to washing with 5 liters of water, for a contact time of 10 minutes, a pressure of 1 bar and a temperature of 75° C.

The washing water was completely recovered, filtered and hot pasteurized in order to obtain a flavored beverage. The food product with reduced caffeine content was instead desiccated in order to bring it back to the form of ground powder, until a moisture content not exceeding 11% was obtained, and then cooled and packaged.

Experimental Data

Roasted coffee in granules before washing (250 g) and roasted coffee with reduced caffeine content obtained after washing and drying from Example 1 (250 g) were subjected to analysis in order to determine the caffeine content. The flavored beverage obtained (5 liters) was also analyzed. The results are reported in the following Table 1. The test method used was ISO 20481:2008.

TABLE 1
caffeine content

| | |
|---|---|
| Roasted coffee in granules before washing | 1.157 g/100 g |
| Roasted coffee with reduced caffeine content | 1.142 g/100 g |
| Flavored beverage | 0.007 g/l |

From the results it is possible to appreciate that the roasted coffee obtained has a reduced caffeine content compared to the raw material used at the start. This caffeine content is intermediate between a traditional coffee and a decaffeinated coffee, resulting in a new type of coffee with reduced caffeine content. The flavored beverage, in this case, has a very low caffeine content.

In order to investigate the sensory and organoleptic properties of the roasted coffee with reduced caffeine content obtained in Example 1 and compare them with the sensory and organoleptic properties of the roasted coffee in granules before washing, a tasting test was carried out using a sensory panel. The sensory panel is made up of 6 people specifically trained for this purpose. A coordinated number of espresso coffees were prepared by means of the same machine for preparing coffee, under the same extraction conditions and the same volume in the cup, using the roasted coffee with reduced caffeine content obtained in Example 1, ground to an appropriate granulometry. The 6 people on the sensory panel, after proceeding with the tasting, assigned a score from 1 to 10, where the score 1 indicates that there is no affinity between the espresso coffee prepared with the roasted coffee before washing and the espresso coffee prepared with the roasted coffee with reduced caffeine content obtained in Example 1, while the score 10 indicates that the affinity is almost equal. To this end, the people involved took into consideration the following tasting parameters: taste (sweet, bitter, acid), flavor, aroma, tactile sensations (thermal, body, viscosity and astringency characteristics).

Scores from 1 to 3 are considered unsatisfactory, scores from 4 to 7 are considered sufficient, and scores from 8 to 10 are considered very satisfactory. In order to offer a roasted coffee with reduced caffeine content that will be appreciated on the market, scores from 4 to 7 and from 8 to 10 are considered acceptable.

Below is Table 2, which shows the results of the tasting test using the sensory panel with 6 people.

TABLE 2
tasting test

| Person | Score |
|---|---|
| Subject 1 | 9 |
| Subject 2 | 10 |
| Subject 3 | 10 |
| Subject 4 | 10 |
| Subject 5 | 7 |
| Subject 6 | 10 |

From the results of the tasting test obtained, it emerges that the espresso coffee obtained with the roasted coffee with reduced caffeine content is absolutely comparable and similar to the espresso coffee obtained with the roasted coffee before washing.

Regarding the flavored beverage, its tasting revealed it to be very light, sweet and with a light aroma of coffee and hints of fruit. It can be a valid substitute for water and can be drunk in quantity, considering the low level of caffeine found in this specific case (see Table 1). Obviously, by increasing the temperature and/or time and/or pressure, the flavored beverage will gradually have a more marked taste and sensory properties and higher caffeine content, while the coffee obtained will have lighter sensory properties and taste and a lower caffeine content.

The Applicant has also found that essentially the same results are obtained, both in terms of analysis of the caffeine content and also of the tasting test, with the coffee with reduced caffeine content subjected to grinding before washing in water of Example 2 and with the corresponding flavored beverage obtained.

It is clear that modifications and/or additions of steps and/or parts may be made to the method to produce food products and to the food products thus obtained as described heretofore, without departing from the field and scope of the present invention as defined by the claims.

It is also clear that, although the present invention has been described with reference to some specific examples, a person of skill in the art shall certainly be able to achieve many other equivalent forms of method to produce food products and food products thus obtained, having the characteristics as set forth in the claims and hence all coming within the field of protection defined thereby.

In the following claims, the sole purpose of the references in brackets is to facilitate reading: they must not be considered as restrictive factors with regard to the field of protection claimed in the specific claims.

1. A method to produce food products, wherein said method comprises:
supplying a food raw material natively containing caffeine, wherein said food raw material has been subjected to roasting;
washing said food raw material subjected to roasting, in order to reduce its caffeine content and also extract a determinate quantity of aromas;
drying said food raw material, roasted and subjected to washing, in order to produce with it a food product with reduced caffeine content;
complete recovery of the washing water to produce a flavored beverage with it, without processing waste of said method.

2. The method as in claim 1, wherein said food raw material natively containing caffeine is selected from a group consisting of coffee, tea, cocoa, mate, guarana, cola.

3. The method as in claim 1, wherein said method comprises, after drying, cooling of the food product with reduced caffeine content.

4. The method as in claim 1, wherein said method provides that the completely recovered washing water is subjected to pasteurization.

5. The method of claim 1, wherein the food raw material subjected to roasting is supplied in the form of granules, grains, seeds, beans, leaves.

6. The method of claim 1, wherein, before washing, the food raw material subjected to roasting is subjected to grinding and the ground powder obtained is then subjected to washing in water.

7. The method of claim 1, wherein said washing provides a contact time between the food raw material and the washing water between 1-2 seconds and 200 hours.

8. The method of claim 1, wherein said washing provides a pressure between 1 bar and 20 bar.

9. The method of claim 1, wherein said washing provides a temperature between 5° C. and 100° C.

10. A food product with reduced caffeine content obtainable with the method of claim 1.

11. A flavored beverage obtainable with the method of claim 1.

12. The method of claim 3, wherein said method comprises packaging of the food product with reduced caffeine content.

13. The method of claim 4 wherein said method comprises, before pasteurization, that the completely recovered washing water is subjected to filtration.

14. The method of claim 4, wherein downstream of the pasteurization, the flavored beverage thus obtained is subjected to bottling.
